(19) United States
(12) Patent Application Publication
(10) Pub. No.: US 2026/0300939 A1
(43) Pub. Date: Oct. 1, 2026

(54) Intelligent Matchmaking System for Dynamic Social Networking

(71) Applicants: Dan Fisher, Longmont, CO (US); SHUBHAM CHANDRA, Katy, TX (US)

(72) Inventors: Dan Fisher, Longmont, CO (US); SHUBHAM CHANDRA, Katy, TX (US)

(21) Appl. No.: 19/090,969

(22) Filed: Mar. 26, 2025

(51) Int. Cl. G06Q 50/00; G06N 3/042; G06N 3/0985

(52) U.S. Cl. CPC G06Q 10/40; G06N 3/042; G06N 3/0985

(57) ABSTRACT

The present invention provides a system and method for intelligent matchmaking using Graph Neural Networks (GNNs) and Model-Agnostic Meta-Learning (MAML) to perform adaptive user clustering and personalized recommendations. Users are modeled as graph nodes with multi-dimensional feature vectors capturing demographic, behavioral, and interest-based data. The system employs GraphSAGE for inductive embedding generation and MAML for few-shot learning, enabling scalable onboarding and rapid adaptation for cold-start users. A hierarchical meta-learning framework dynamically adjusts to evolving user behavior, while subgraph matching supports context-aware group formation. Temporal attention mechanisms and similarity-based scoring enhance real-time matchmaking accuracy. The invention supports applications in social networking, professional matchmaking, healthcare, and event-driven platforms by delivering interpretable, privacy-preserving, and scalable user alignment in dynamic digital environments.

### BACKGROUND

The present invention relates to artificial intelligence-driven social networking systems, specifically integrating meta-learning and graph neural networks (GNNs) to facilitate intelligent matchmaking and relationship discovery in digital environments. This invention employs Graph Sample and Aggregate (GraphSage) for inductive learning of social graphs and Model-Agnostic Meta-Learning (MAML) for few-shot adaptation, ensuring personalized and scalable social alignment across diverse digital platforms.

The lack of adaptive and context-aware matchmaking solutions in networking platforms results in users feeling overwhelmed by excessive, low-relevance connections or failing to find individuals who align with their interests and objectives. A more dynamic, AI-driven approach is needed to create meaningful relationships by identifying latent similarities and shared behavioral patterns in real-time. This patent application and research did not involve any federally or government-sponsored research or development-based funding.

### TECHNICAL FIELD

The present invention pertains to artificial intelligence-based social networking systems, with particular emphasis on the integration of meta-learning and graph neural networks (GNNs) to enable intelligent matchmaking and dynamic relationship discovery within digital environments. The system utilizes GraphSAGE for inductive representation learning over social graphs, allowing for scalable embedding generation even in the presence of previously unseen users or nodes. In parallel, the system incorporates Model-Agnostic Meta-Learning (MAML) to facilitate few-shot adaptation, enabling rapid personalization based on minimal user data. Through the synergistic application of these machine learning techniques, the invention overcomes inherent limitations of traditional transductive GNNs and static recommendation engines. It delivers a robust and adaptive solution for real-time user alignment, personalized recommendations, and social clustering across a wide range of networking platforms. This architecture supports continuous learning from evolving interaction patterns and user behaviors, thereby enhancing user experience and enabling the formation of contextually meaningful connections in both professional and social digital ecosystems.

### TECHNICAL BACKGROUND OF THE INVENTION

Graph-based approaches, such as Graph Neural Networks (GNNs), are effective in modeling relationships by analyzing graph-structured social data. However, conventional transductive learning models require extensive labeled data, limiting their adaptability to new users.

Meta-learning, particularly Model-Agnostic Meta-Learning (MAML), enables powerful few-shot learning capabilities that allow our system to generalize effectively to new users with minimal training data. This integration of GraphSAGE with meta-learning directly addresses critical limitations in conventional graph-based systems, delivering a robust framework for real-time adaptive matchmaking and personalized recommendations across networking and social applications.

While the GraphSAGE-MAML pipeline forms the cornerstone of our approach, we recognize the rich landscape of alternative graph-based machine learning techniques that complement our user clustering methodology. Graph Transformers represent one such alternative, employing sophisticated self-attention mechanisms to capture long-range dependencies throughout the graph-effectively overcoming GraphSAGE's inherent limitation of fixed-size neighborhood sampling. Similarly, Graph Attention Networks (GATs) enhance representation learning by assigning learnable weights to each neighbor during the aggregation process, offering more nuanced and context-sensitive modeling compared to GraphSAGE's uniform treatment of neighboring nodes.

For effective dimensionality reduction, UMAP (Uniform Manifold Approximation and Projection) substantially outperforms traditional meta-learning embeddings by preserving both local and global graph structures while maintaining exceptional scalability across larger datasets. Despite these valuable alternatives, meta-learning maintains unique advantages in our system architecture. Unlike conventional task-specific optimization approaches, meta-learning frameworks such as MAML and Prototypical Networks excel at learning generalized strategies that rapidly adapt to new or evolving graph tasks with minimal data requirements. This adaptability proves especially valuable in cold-start scenarios or when user behavior undergoes significant shifts over time. For instance, a meta-learned GNN can dynamically adjust to emerging user communities or seamlessly integrate new node features without requiring comprehensive retraining.

To further enhance our current pipeline, we propose implementing a hierarchical meta-learning framework where base-level GNNs are specifically trained to learn user representations within individual clusters, while a higher-level meta-learner orchestrates knowledge transfer optimization across these clusters. This sophisticated hierarchical design can be further augmented with temporal dynamics through a graph attention mechanism that intelligently weights historical interactions based on their recency and relevance. Moreover, incorporating contrastive learning objectives would significantly improve embedding separation, yielding more discriminative and meaningful clusters.

To ensure consistent performance and scalability across diverse user segments, our system employs Bayesian optimization for automated hyperparameter tuning. This adaptive configuration methodology enables the model to dynamically adjust its complexity based on various factors including local graph density, user behavior variability, and application-specific constraints. Collectively, this advanced architectural approach delivers a meta-learning-enhanced, context-aware, and computationally efficient system that evolves naturally alongside dynamic user networks.

### PRIOR ART

The present invention introduces a groundbreaking approach to social networking matchmaking that substantially surpasses existing solutions through its innovative integration of advanced machine learning techniques. Traditional social networking algorithms suffer from fundamental limitations that restrict their effectiveness in creating meaningful connections.

Conventional transductive Graph Neural Network (GNN) models depend heavily on pre-existing labeled data, severely constraining their ability to generalize to new users or adapt to evolving social dynamics. Similarly, keyword-based and heuristic matching techniques typically generate superficial or contextually irrelevant pairings that fail to capture the nuanced dimensions of human compatibility. Most conventional recommendation systems struggle with notorious cold-start problems and scalability issues, making them inadequate for dynamic social environments. To address these shortcomings, our invention leverages GraphSAGE for inductive graph learning and Model-Agnostic Meta-Learning (MAML) for few-shot adaptation, delivering an adaptive, scalable, and user-centric solution that transforms relationship discovery in digital ecosystems.

The invention offers significant technological advancements over specific prior art solutions in the field, surpassing the capabilities of well-known patented systems. For instance, Facebook's patent (US20140089400A1), titled “Social Networking System and Method,” relies on fixed cluster inference from social graphs, using features like mutual friends and profile attributes to group users. While effective for static clustering, this approach is hindered by its transductive learning framework, which requires a fully observed graph during training. Embeddings are computed only for nodes present in the initial dataset, necessitating retraining—scaling at O(n²) complexity for n nodes—whenever new users join, a process that becomes computationally prohibitive for large, dynamic graphs. Additionally, its dependence on static features lacks mechanisms to dynamically weigh or update based on real-time behavior, potentially missing latent patterns like shifting interests not reflected in fixed social ties. In contrast, our system employs dynamic, real-time adaptation through few-shot learning, enabling intelligent matching of new users with minimal data, and uses GraphSAGE's inductive capabilities to generate embeddings for unseen nodes without full model retraining, ensuring unprecedented scalability.

Similarly, Match.com's patent (U.S. Pat. No. 6,735,568B1), “Method and System for Identifying People Compatible with a User,” utilizes static compatibility scoring mechanisms based on user-provided attributes such as preferences and demographics. This system relies on heuristic rules—essentially weighted sums of attribute matches—rather than learned representations, lacking the ability to capture complex, non-linear relationships that GNNs could model through neighborhood aggregation. A critical limitation is its complete disregard for graph context, such as social ties or mutual interactions, reducing matches to isolated attribute comparisons that fail to infer deeper compatibility from network structure. This approach also exacerbates the cold-start problem, as new users must supply extensive profile data for accurate scoring, with no mechanism to leverage sparse inputs or generalize from existing users. Our invention, however, harnesses GraphSAGE to learn embeddings from both user features and graph relationships, while MAML mitigates cold-start issues by adapting with minimal data, delivering a more dynamic and context-aware matchmaking solution that surpasses these superficial pairings.

Drawbridge/LinkedIn's patent (US20150199635A1), “Cross-Device User Identification,” focuses primarily on identity-centric cross-device resolution using graph-based methods, optimized for advertising and tracking purposes. While innovative, this system is narrowly tailored to linking devices rather than fostering relationship discovery, with its GNN (if present) designed for node classification rather than embedding generation for social matchmaking. Its feature set is limited to device-centric signals like IP addresses and cookies, neglecting richer behavioral or interest-based dimensions essential for comprehensive user modeling. Furthermore, its graph traversal approach, such as breadth-first search, becomes inefficient for dense social graphs with high connectivity, as frequent edge updates demand significant re-computation. Our system, by contrast, models users as multi-dimensional feature vectors incorporating demographic, behavioral, and interest-based signals, with GraphSAGE's inductive learning ensuring scalability across growing networks, far exceeding this patent's identity-centric scope and offering a more holistic approach to social alignment.

The key technical advantages of the invention stem from its unique combination of cutting-edge technologies, setting it apart from both traditional approaches and specific prior art. The integration of GraphSAGE and MAML enables real-time adaptation and personalized matchmaking that evolves with user preferences, far surpassing static models requiring complete retraining. Unlike simplistic feature vectors or fixed clusters in conventional systems, our approach captures multi-dimensional vectors encompassing demographic, behavioral, and interest signals, providing a richer user representation. Where traditional methods falter with poor cold-start handling, our meta-learning module continuously fine-tunes representations for new users with minimal data, addressing one of the most persistent challenges in recommendation systems. Scalability, a frequent limitation in prior solutions requiring full retraining, is achieved through inductive learning, allowing continuous scaling as new users join the network. Beyond individual matching, our implementation of subgraph matching facilitates intelligent group formation based on complex relationship patterns, while a context-aware re-ranking system refines recommendations based on evolving user engagement, replacing the fixed or slowly updating models of the past. By combining these innovative elements, the system delivers an adaptive, intelligent approach to relationship discovery that fundamentally transforms social networking matchmaking.

To fully contextualize the invention's novelty, it is essential to consider recent non-patent advancements in GNNs and meta-learning that complement or compete with our approach. Graph Attention Networks (GATs), introduced by Velickovic et al. in 2018 (ICLR), enhance GNNs with attention mechanisms, assigning learnable weights to neighbors during aggregation for context-sensitive modeling—unlike GraphSAGE's uniform sampling. However, GATs remain transductive, requiring retraining for new nodes, and their attention computation increases complexity (O(|E|) per layer, where |E| is edge count), trading off scalability. Our system prioritizes GraphSAGE's inductive simplicity but acknowledges GATs as an alternative for potential integration. Graph Isomorphism Networks (GINs), proposed by Xu et al. in 2019 (ICLR), match the discriminative power of the Weisfeiler-Lehman test using sum aggregation and multi-layer perceptrons, improving structural representation over GraphSAGE's mean pooling, though their computational intensity limits suitability for dynamic graphs. We adopt GIN as an optional enhancement, balancing expressiveness with efficiency. In meta-learning, Reptile, introduced by Nichol et al. in 2018 (arXiv), offers a simpler alternative to MAML using first-order gradients, but lacks MAML's precision for variable tasks, leading us to favor MAML's robustness. Temporal Graph Networks (TGNs), presented by Rossi et al. in 2020 (KDD), encode edge timestamps to capture evolving relationships, aligning with our proposed temporal attention mechanism, though they require time-stamped data. Industry-wise, Pinterest's PinSAGE (Ying et al., 2018, KDD) adapts GraphSAGE for web-scale recommendation, but focuses on items without meta-learning for cold-start users, unlike our broader social scope.

This combined analysis highlights how our invention surpasses both traditional and emerging social recommendation systems—ranging from static matching engines to advanced contrastive graph learning models. While models like MultiCSR represent the latest academic frontier in multi-view contrastive learning, they still rely on predefined graph structures and contrastive regularization, lacking inductive learning capability and adaptive generalization.

Legacy systems such as Facebook's US20140089400A1 depend on transductive embeddings and static user clusters, making them computationally expensive and inflexible in dynamic settings. Match.com's U.S. Pat. No. 6,735,568B1 uses deterministic compatibility scoring without relational modeling, and LinkedIn's US20150199635A1 is optimized for identity linking, not relationship discovery.

In contrast, our invention combines GraphSAGE's inductive representation learning with Model-Agnostic Meta-Learning (MAML) to enable few-shot adaptation for unseen or cold-start users. It also introduces a hierarchical temporal attention mechanism and supports real-time dynamic re-ranking-offering a holistic framework that scales and evolves with user behavior, without retraining from scratch or relying on curated contrastive views.

TABLE 1
Comparative Table: Invention vs. Prior Art

| | | | | | Our |
|---|---|---|---|---|---|
| | Facebook | Match.com | LinkedIn | MultiCS | Invention |
| | (US2014008940 | (US6735568 | (US2015019963 | R (Chenet al., | (GraphSAGE + |
| Feature | 0A1) | B1) | 5A1) | 2024) | MAML) |
| Core | Transductive | Heuristic | Device Graph | Contrastive | Inductive |
| Method | GNN | Rules | Traversal | Multi- | GNN + |
| | | | | View | Meta- |
| | | | | GNN | Learning |
| Cold-Start | No | No | No | Partial | Yes (few- |
| Adaptation | | | | (via | shot |
| | | | | embeddings) | MAML) |
| Inductive | No | No | No | No (uses | Yes |
| Learning | | | | LightGCN) | (GraphSAGE) |
| Support | | | | | |
| Personalization | Static clusters | Rule-based | None | Dynamic | Personalized |
| | | scoring | | via view | meta- |
| | | | | fusion | initialization |
| Scalability | Poor (O(n²) | Manual | Inefficient | Good for | Excellent |
| (Ongoing | retraining) | updates | traversal | static | (no |
| Users) | | | | graphs | retraining) |
| Multi- | Partial | None | No | Yes (U-I, | Optional, |
| Relational | | | | U-U, I-I | but not |
| View | | | | graphs) | required |
| Support | | | | | |
| Contrastive | No | No | No | Yes | Optional |
| Learning | | | | (multi- | (not |
| | | | | view | required for |
| | | | | InfoNCE) | core) |
| Temporal | No | No | No | No | Yes |
| | | | | explicit | (temporal |
| Adaptation | | | | model | attention |
| | | | | | w(t)) |
| Explainability | No | No | No | Limited | Yes (salient |
| Layer | | | | | features, |
| | | | | | heatmaps) |
| Privacy | None | None | No | Not | Yes |
| | | | | | (federated |
| Support | | | | specified | + |
| | | | | | differential |
| | | | | | privacy) |

### SUMMARY OF THE INVENTION

This invention redefines the landscape of digital networking by integrating advanced AI technologies to deliver personalized, scalable, and secure social matching. It addresses the limitations of traditional systems—such as static recommendations, inflexible group formation, and data-intensive onboarding—through an adaptive, learning-based architecture. Leveraging GraphSAGE for inductive learning, the system seamlessly accommodates new users without the need for full retraining, while Model-Agnostic Meta-Learning (MAML) enables few-shot adaptation, ensuring rapid and accurate matchmaking even with minimal user data. Intelligent clustering dynamically adjusts social groupings in response to evolving user behavior, fostering meaningful and context-aware interactions. Privacy is embedded at the core of the system design, with federated learning and differential privacy mechanisms ensuring minimal personal data exposure while maintaining high-quality recommendations. Beyond technical performance, the invention also serves a broader societal need by proactively addressing social isolation. By decoding subtle behavioral signals, it empowers users—particularly those who are introverted or experience loneliness—to form authentic, low-friction connections, transforming digital platforms into inclusive and emotionally intelligent social ecosystems.

### DETAILED DESCRIPTION OF THE INVENTION

The present invention provides a dynamic, adaptive system for intelligent social connection facilitation through the integration of graph neural networks (GNNs), meta-learning, and similarity-based matchmaking. The system models social data as a structured graph and applies a combination of inductive representation learning and few-shot learning to enable personalized recommendations, even for users with minimal prior data.

At the foundation of the system is a graph-based social data structure. Each user is modeled as a node in the graph, represented by a feature vector that encapsulates diverse dimensions of identity and behavior. These features include: (a) personal and demographic attributes, such as age, gender, education, profession, and industry; (b) behavioral signals, including event participation frequency, interaction volume, social engagement metrics, and temporal activity patterns; and (c) interest-based embeddings, derived from user-generated content, social media profiles, or survey responses, often encoded via natural language processing models or latent semantic indexing. Edges between nodes represent relationships and are weighted based on multiple factors, such as interaction frequency, recency, shared activities, mutual content preferences, or inferred compatibility. These edge weights can be interpreted as social tie strength and are used to guide embedding learning and matchmaking processes.

To learn structured representations from this graph, the system employs a GraphSAGE-based graph neural network, which supports inductive learning. The model aggregates features from each node's local neighborhood. The embedding update is defined as:

$${h}_{v}^{k} = σ ( {W}^{k} \cdot CONCAT {h}_{v}^{( k - 1 )} , AGGREGATE ( \{ {h}_{v}^{k - 1} , ∀ v ∈ N ( v ) \} ) ) \qquad Eq . 1$$

where:

$${h}_{v}^{k}$$

represents the updated embedding of node v at layer k.
w^{k} is the trainable weight matrix at layer k.
N (v) represents neighboring nodes.
The AGGREGATE function uses a mean pooling mechanism to capture global patterns in health data.
σ is a non-linear activation function.
CONCAT represents the concatenation operation

This aggregation captures both the structural and contextual characteristics of users. Two-hop neighborhoods are used to enhance contextual depth.

A key innovation of the present invention lies in the integration of Model-Agnostic Meta-Learning (MAML), a powerful gradient-based meta-learning technique designed to optimize machine learning models for rapid adaptation across multiple tasks with minimal retraining. Unlike conventional deep learning approaches that demand extensive labeled datasets and prolonged training cycles, MAML enables the system to converge on task-specific solutions using only a small number of examples. This characteristic makes it particularly well-suited for data-scarce environments, such as early-stage disease diagnosis, emerging financial fraud schemes, and novel cybersecurity threats.

The MAML optimization process is defined as:

$${θ}^{′} = θ - α {∇}_{θ} {L}_{{T}_{i}} ( {f}_{θ} ) , \qquad Eq . 2$$

$${θ}^{′} = θ - β {∇}_{θ} {\sum }_{{T}_{i}} {L}_{{T}_{i}} ( {f}_{{θ}_{i}} ) ,$$

In this equation:

where:
represents the model parameters
θ′ represents the updated model parameters after few-shot learning.
α, β Inner-loop and outer-loop learning rates, respectively
L_{T}_{ᵢ} is Loss Function for Task Tᵢ
This process enables the model to generalize rapidly to new users or tasks.

The term is a second-order gradient (i.e., curvature-based adjustment), which ensures that the model is not simply learning to perform well on individual tasks but is explicitly optimized for adaptability across tasks. This meta-objective allows the model to identify optimal initial parameters that can quickly converge to new, unseen tasks with just a few gradient updates. For instance, in cold-start scenarios, MAML fine-tunes embeddings using small support sets, ensuring accurate predictions for users with sparse interactions, as seen in LinkedIn professional networking.

This curvature-aware optimization is a critical enabler for anomaly detection and adaptation. For example, in medical diagnostics, the system can detect early indicators of rare diseases from minimal patient data, supporting timely intervention without requiring population-scale datasets. In cybersecurity, the same architecture can adapt to identify novel attack vectors or intrusion patterns with only a few labeled examples, without full model retraining. Similarly, in financial applications, the system can rapidly learn to recognize new fraud techniques by generalizing from a few flagged transactions.

When embedded within the graph-based social recommendation framework of this invention, MAML ensures that even new users with little or no historical interaction data can receive personalized, high-quality recommendations. The training process involves episodic learning, where the graph is partitioned into support sets and query sets. The meta-learner is trained to optimize initial model parameters such that a small number of gradient descent steps on the support set yields good performance on the query set. These embeddings enable the system to generalize to unseen users without retraining, as demonstrated in examples like Facebook user grouping and PTSD patient clustering, where clusters reflect shared behavioral or clinical patterns. MAML complements this by optimizing model parameters for few-shot learning, allowing rapid adaptation to new users or evolving patterns with minimal data.

These gradient-based updates allow for real-time refinement of node embeddings with minimal data, enabling highly personalized matchmaking recommendations as users begin interacting with the system.

Once embeddings are generated and adapted, the system performs meaningful connection computation. For every user node, the system evaluates pairwise similarity to other nodes using cosine similarity or Euclidean distance metrics. Given two node embeddings A and B, the cosine similarity score is calculated as:

$$cosine similarity = \frac{A \cdot B}{\vert A \vert \vert B \vert} \qquad Eq . 3$$

where:
A·B is the dot product of vectors A and B.
∥All∥ and ∥B∥ are the magnitudes (L2 norms) of vectors A and B, respectively.
This formula measures the cosine of the angle between the two vectors, providing a similarity score that ranges from −1 to +1, where 1 indicates perfect similarity, 0 indicates orthogonality (no similarity), and −1 indicates perfect dissimilarity

Users whose similarity scores exceed a predefined affinity threshold are considered high-potential matches and are recommended to each other. This threshold-based filtering ensures that only meaningful, contextually relevant matches are surfaced to the user.

Furthermore, the invention supports group-based social formation using subgraph matching techniques. By analyzing clusters of users with mutual affinities and overlapping features, the system identifies communities or interest groups—such as event cohorts, professional clusters, or thematic discussion groups. These subgraphs are evaluated based on intra-group connectivity and cohesion metrics, facilitating the creation of dynamic, intelligent social clusters.

The invention also incorporates context-aware re-ranking, continuously monitoring evolving user behavior such as message exchanges, profile visits, or shared content interactions. As users engage with the system, their embeddings and interaction graphs are updated, and recommendations are re-scored in real-time to reflect the most relevant, active, and compatible connections.

In sum, this invention presents a novel algorithmic framework that unifies inductive graph representation learning and meta-learning to deliver a robust, scalable, and adaptive solution for intelligent relationship discovery. The system not only overcomes the limitations of static matching and cold-start scenarios but also enables fine-grained, real-time personalization, making it highly applicable to diverse domains including social networking, professional platforms, and B2B marketplaces. To further enhance user trust and interpretability, the system includes an explainability layer configured to generate interpretable rationales for matchmaking decisions. This layer identifies and visualizes the salient node features, cosine similarity scores, and edge weight contributions that most influenced each recommendation. The explainability mechanism operates alongside the prediction engine and provides feedback to users or system administrators in the form of ranked feature importance, similarity heatmaps, or textual justifications. This functionality is particularly valuable in regulated environments such as healthcare, recruitment, and finance, where transparency in algorithmic decisions is critical for compliance and ethical standards.

In a further embodiment of the invention, the system architecture is designed with a modular and extensible framework that supports the interchangeable integration of advanced graph neural network (GNN) models, including Graph Attention Networks (GAT) and Transformer-based GNN hybrids, as alternatives to the default GraphSAGE architecture. This modularity allows the system to dynamically adjust its embedding strategy based on application-specific requirements, thereby enhancing representational fidelity and enabling the capture of more complex, high-dimensional social relationships. The incorporation of GAT facilitates attention-based aggregation by assigning learnable weights to neighboring nodes, allowing the model to prioritize contextually significant relationships over uniformly aggregated features. Transformer-based GNN hybrids further extend this capability by modeling long-range dependencies and extracting deeper interaction patterns across the graph through self-attention mechanisms.

In conjunction with architectural flexibility, the system is engineered with robust privacy-preserving mechanisms to enable secure and regulation-compliant deployment in enterprise and sensitive data environments. Specifically, federated learning is employed to ensure that user data remains decentralized and is processed locally on individual devices or within secure servers. Only anonymized model updates are transmitted, leveraging secure aggregation protocols to prevent data leakage and unauthorized inference. Additionally, differential privacy is implemented by injecting calibrated noise (ε=0.1) into model gradients during meta-learning updates, thereby providing formal guarantees against re-identification of individual users. These privacy safeguards ensure full compliance with data protection regulations such as the General Data Protection Regulation (GDPR), while maintaining the integrity and utility of the learning process.

In another embodiment of the invention, the system is configured to receive and process heterogeneous data streams, including but not limited to textual content, audio signals, and video inputs. Each modality is processed through specialized embedding models tailored to its data type—for example, Bidirectional Encoder Representations from Transformers (BERT) for natural language text, Wav2Vec for speech and audio signal processing, and Contrastive Language-Image Pretraining (CLIP) for fusing visual and textual data. These modality-specific embeddings are subsequently integrated into a unified node feature representation that captures the multifaceted identity and behavioral attributes of each user. This multimodal fusion enables a more comprehensive understanding of users, enhancing the depth and accuracy of matchmaking decisions. Complementing this capability, the system further refines user embeddings through time-weighted attention mechanisms applied across historical interaction sequences. This temporal modeling technique assigns higher significance to more recent user behaviors, preferences, and interactions, ensuring that the matchmaking engine prioritizes current context and evolving user intent. Together, these innovations enable the system to generate dynamic, context-aware, and deeply personalized social recommendations that adapt fluidly over time and across diverse media formats.

In another embodiment of the invention, the graph neural network component may incorporate advanced architectures beyond GraphSAGE, such as Graph Isomorphism Networks (GIN) and Principal Neighborhood Aggregation (PNA) models, to enhance the expressive power of node representation learning. Graph Isomorphism Networks (GIN) are designed to match the discriminative capability of the Weisfeiler-Lehman graph isomorphism test, making them highly effective for learning graph-structured data with subtle topological differences. GIN achieves this by employing a sum aggregation function followed by a multi-layer perceptron (MLP), enabling the model to distinguish graph structures that simpler aggregators may fail to separate. This architecture allows the system to capture fine-grained relational patterns in user behavior and interactions, improving the fidelity of node embeddings used for matchmaking and clustering. Complementing GIN, Principal Neighborhood Aggregation (PNA) offers a highly expressive aggregation strategy that combines multiple statistical aggregators—such as mean, max, min, and standard deviation—along with degree-scalers to adjust for node connectivity. By leveraging this combination, PNA captures both the central tendency and variability of node neighborhoods, allowing for robust generalization across diverse graph topologies. The integration of GIN or PNA within the system's architecture enhances its ability to model complex and heterogeneous social structures, providing more accurate and adaptive recommendations across various networking domains.

### Advantages

The invention offers several significant advantages over traditional networking systems. One of its key benefits is the ability to provide personalized and adaptive social matching, which enhances user experience by uncovering latent social alignments that might otherwise go unnoticed. This AI-driven approach not only deepens connections but also ensures that users are more likely to engage with others who share similar interests or goals. Additionally, the system's scalability, facilitated by GraphSAGE, allows for the continuous onboarding of new users without disrupting the network's performance, making it highly adaptable to growing communities. Furthermore, the integration of few-shot learning for cold start users ensures that even those with limited data can quickly find meaningful connections, addressing a common challenge in many social platforms. The context-aware group formation feature dynamically adjusts connections based on evolving user behavior, ensuring that social interactions remain relevant and engaging. Importantly, the system prioritizes privacy and security, ensuring that users can enjoy high-quality recommendations while maintaining control over their personal data. Overall, these advantages make the invention a powerful tool for enhancing social networking experiences while safeguarding user privacy and trust.

### EXAMPLES

### Example 1

Demonstrates the practical implementation of our “Intelligent Matchmaking System for Dynamic Social Networking” patent application, showcasing the synergistic integration of GraphSAGE and Model-Agnostic Meta-Learning (MAML) technologies for social network user analysis and clustering.

This implementation processes Facebook user data through a sophisticated pipeline that begins with comprehensive data preprocessing, where diverse user attributes are transformed into normalized feature vectors suitable for machine learning. The system then constructs a graph representation with users as nodes, establishing edges based on a carefully calibrated cosine similarity threshold of 0.8 to ensure meaningful connections between similar users.

At the core of the system, GraphSAGE generates node embeddings through a two-layer convolutional architecture (128 neurons in the hidden layer, 64 dimensions in the output layer), effectively capturing both individual user attributes and their network relationships. These embeddings undergo dimensionality reduction to 32 principal components via PCA, preserving essential variance while optimizing computational efficiency.

The MAML component enables rapid adaptation to new users through few-shot learning, with hyperparameters optimized through extensive experimentation: learning rate of 0.01, inner learning rate of 0.05, and hidden dimension of 256 neurons. Regularization techniques include dropout (0.5), weight decay (1e-4), and batch normalization, collectively preventing overfitting and ensuring stable training.

The training process involves 200 epochs for GraphSAGE initialization followed by 500 MAML epochs with early stopping (patience: 30), using balanced data partitioning (support, query, and validation sets of 50 samples each) for robust model evaluation. Performance metrics demonstrate exceptional accuracy (99.67% for GraphSAGE, 97.00% for MAML) and F1-scores (99.67% and 97.00% respectively), validating the system's effectiveness.

This example not only substantiates the patent's claims regarding adaptive, intelligent matchmaking but also provides concrete technical specifications that enable skilled practitioners to reproduce the invention. As one of several implementations showcased in the patent, it demonstrates the system's versatility across different social networking contexts, with subsequent examples extending to LinkedIn professional networking and other domains.

The dataset was meticulously constructed to simulate a sample of 1000 Facebook users. Each user is assigned a unique identifier, ranging from user_1 to user_1000, ensuring individuality in the dataset. Age groups are categorized to reflect a broad demographic representation, including 18-24, 25-34, 35-44, 45-54, and 55+. To simulate variability in user engagement, metrics like the number of friends, posts, likes, and comments are randomly assigned within specified ranges. User preferences are also simulated, with interests drawn from a predefined list including Sports, Music, Politics, Technology, Fashion, Travel, Food, and Gaming. Community involvement is categorized as High, Medium, or Low, and the number of groups each user has joined is also simulated. For advertising purposes, each user is assigned an ad category from a list like Electronics, Fashion, Travel, Health, Automotive, Entertainment, Food & Beverage, and Education, with the level of interaction with these ads simulated to range from 0 to 100. This dataset is stored in a pandas DataFrame and saved as a CSV file in a specified directory on Google Drive. This simulated dataset serves as a proxy for real-world data, allowing for the testing and refinement of machine learning models when actual data is limited, biased, or sensitive. Simulated datasets are used for illustrative purposes; real-world performance may vary and will be validated in live deployments.

TABLE 1
TRUNCATED DATASET FOR FACEBOOK USERS

| | | | | | num_{—} | | community_{—} | groups_{—} | | ad_{—} |
|---|---|---|---|---|---|---|---|---|---|---|
| user_id | age_group | num_friends | num_posts | num_likes | comments | interests | involvement | joined | ad_category | interactions |
| user_1 | 45-54 | 405 | 939 | 1304 | 972 | Technol [symbol] | Low | 7 | Health | 25 |
| user_2 | 55+ | 373 | 525 | 3300 | 1670 | Music | Low | 16 | Automoti [symbol] | 32 |
| user_3 | 35-44 | 182 | 333 | 361 | 1251 | Sports | Medium | 17 | Travel | 47 |
| user_4 | 55+ | 425 | 1 | 3727 | 622 | Music | High | 11 | Electroni [symbol] | 78 |
| user_5 | 55+ | 342 | 374 | 1284 | 306 | Technol [symbol] | High | 16 | Automoti [symbol] | 1 |

[symbol]

indicates data missing or illegible when filed

The algorithm used for this example is a sophisticated approach to graph-based machine learning, specifically tailored for social network analysis. It begins with data loading and preprocessing, where a dataset of simulated Facebook users is loaded from a CSV file. This data is preprocessed by removing non-feature columns like user_id, encoding categorical variables such as age_group using one-hot encoding, and selecting only numeric features for further analysis.

Next, graph construction takes place where each user is represented as a node in the graph. Edges are randomly generated for this example, but in a real-world scenario, these would reflect actual connections or interactions between users.

The core of the algorithm involves the GraphSAGE Model, a type of Graph Neural Network (GNN) designed to learn node embeddings by aggregating information from a node's local neighborhood. This model uses two convolutional layers (SAGEConv) followed by normalization to process the graph data.

Training of the GraphSAGE model focuses on minimizing the mean squared error between the dot product of node embeddings and the dot product of their original features. This process effectively learns to represent users in a lower-dimensional space while preserving their relationships.

After training, embedding normalization is performed using PCA to reduce dimensionality and standardize the data. This step is crucial for preparing the data for clustering.

Clustering is then applied using K-Means, grouping similar users into five clusters based on their embeddings. This step helps in understanding the community structure within the network.

The algorithm introduces MAML (Model-Agnostic Meta-Learning), a meta-learning approach that allows the model to quickly adapt to new tasks. This model includes dropout for regularization and is optimized using the AdamW optimizer, with learning rate scheduling and L2 regularization. Hyperparameter tuning is conducted to optimize the learning rate and hidden dimension.

For prediction and evaluation, the algorithm uses both GraphSAGE and MAML models to predict cluster assignments for new, simulated users. Performance metrics such as accuracy, F1 score, and recall are calculated, and confusion matrices are visualized to assess the effectiveness of the models.

Visualization of the results is achieved through a 3D scatter plot, which illustrates how users are grouped in the embedding space, providing a visual insight into the clustering.

Finally, model saving ensures that both the GraphSAGE and MAML models are preserved for future use or further analysis. This comprehensive approach not only analyzes user behavior in a social network context but also offers potential applications in personalized advertising, community detection, or user recommendation systems.

TABLE 2
PREDICTIONS FOR EXAMPLE 1

| New Person ID | MAML Cluster |
|---|---|
| 1 | 3 |
| 2 | 3 |
| 3 | 2 |
| 4 | 2 |
| 5 | 3 |

The Facebook user clustering implementation employs a sophisticated graph-based approach with carefully optimized parameters. Edge creation utilizes a cosine similarity threshold of 0.8, ensuring meaningful connections between user nodes. The graph architecture features an input dimension corresponding to the feature shape (300, 14), followed by a GraphSAGE hidden layer with 128 neurons and output embeddings of 64 dimensions. For dimensionality reduction, PCA is applied to transform these embeddings into 32 principal components, preserving essential variance while reducing computational complexity. The MAML component is configured with hyperparameters determined through extensive tuning, including an optimal learning rate of 0.01, inner learning rate of 0.05, and hidden dimension of 256 neurons. Regularization techniques incorporate a dropout rate of 0.5, weight decay of 1e-4, and batch normalization after each linear layer to prevent overfitting and ensure stable training. The training process involves 200 epochs for GraphSAGE initialization, followed by 500 MAML epochs with an early stopping mechanism (patience: 30) to prevent overtraining. For each training iteration, the system utilizes balanced data partitioning with support, query, and validation sets of 50 samples each, ensuring robust model evaluation and adaptation.

### Example 2

Demonstrates the practical implementation of our “Intelligent Matchmaking System for Dynamic Social Networking” patent application in the professional networking domain, showcasing the synergistic integration of GraphSAGE and Model-Agnostic Meta-Learning (MAML) technologies for LinkedIn user analysis and clustering.

This implementation processes LinkedIn user data through a sophisticated pipeline that begins with comprehensive data preprocessing, where diverse professional attributes—including job titles, industries, skills, and engagement metrics—are transformed into normalized feature vectors suitable for machine learning. The system then constructs a graph representation with users as nodes, establishing edges based on a carefully calibrated cosine similarity threshold of 0.8 to ensure meaningful professional connections between similar users.

At the core of the system, GraphSAGE generates node embeddings through a two-layer convolutional architecture (128 neurons in the hidden layer, 64 dimensions in the output layer), effectively capturing both individual career attributes and professional network relationships. These embeddings undergo dimensionality reduction to 64 principal components via PCA, preserving essential variance while optimizing computational efficiency for the complex professional data.

The MAML component enables rapid adaptation to new professional users through few-shot learning, with hyperparameters optimized through extensive experimentation: learning rate of 0.01, hidden dimension of 256 neurons, and dropout rate of 0.4. This configuration allows the system to quickly adapt to professionals from emerging industries or with novel skill combinations, addressing the cold-start problem that plagues traditional recommendation systems.

The training process involves 300 epochs for GraphSAGE initialization followed by 150 MAML epochs, using a batch size of 32 samples. Performance metrics demonstrate exceptional accuracy (96.90%) and F1-scores (96.88%), validating the system's effectiveness in professional networking contexts. The resulting clusters effectively group professionals with similar career trajectories, skills, and industry backgrounds, enabling targeted networking recommendations and career development opportunities.

This example substantiates the patent's claims regarding adaptive, intelligent matchmaking in professional contexts, providing concrete technical specifications that enable skilled practitioners to reproduce the invention across different social networking domains.

The dataset simulates a sample of 1000 LinkedIn users, each with a unique user ID. Users are categorized into age groups such as 18-24, 25-34, 35-44, 45-54, and 55+, reflecting a broad demographic representation. Job titles are assigned from a predefined list including Software Engineer, Data Scientist, Product Manager, Designer, Consultant, Marketing Specialist, HR Manager, and Sales Executive. Social engagement metrics like the number of connections, posts, and endorsements are randomly assigned within specified ranges to simulate variability in user engagement. LinkedIn-specific features include industry categorization, the number of influencers followed, ad preferences, content preferences, engagement level, groups joined, skills, education, years of experience, location, company size, job seeking status, and salary range. This dataset is stored in a pandas DataFrame named linkedin_users_df and subsequently saved as a CSV file in a specified directory on Google Drive. Simulated datasets are used for illustrative purposes; real-world performance may vary and will be validated in live deployments.

TABLE 3
TRUNCATED DATASET FOR LINKEDIN USERS

| | | | num_{—} | num_{—} | | influencer_{—} | content_{—} | | | years_of_{—} | |
|---|---|---|---|---|---|---|---|---|---|---|---|
| use | age_group | job_title | connections | posts | industry | follo | preferences | skills | education | experience | location |
| 1 | 45-54 | Designe [symbol] | 936 | 472 | Medi [symbol] | 22 | Webina [symbol] | Proje [symbol] | High [symbol] | 9 | London |
| 2 | 55+ | Designe [symbol] | 477 | 113 | Manu [symbol] | 23 | Infogra [symbol] | Com [symbol] | Asso [symbol] | 28 | Sydney |
| 3 | 35-44 | Designe [symbol] | 354 | 277 | Healt [symbol] | 8 | Videos | Pyth [symbol] | Mast [symbol] | 27 | Toront [symbol] |
| 4 | 55+ | Sales Ex [symbol] | 921 | 499 | Tech [symbol] | 34 | Whitepa [symbol] | Mach [symbol] | Bach [symbol] | 29 | San Fra [symbol] |
| 5 | 55+ | Designe [symbol] | 366 | 413 | Retail | 19 | Whitepa [symbol] | Mark [symbol] | Bach [symbol] | 0 | Sydney |
| 6 | 25-34 | Consult [symbol] | 684 | 467 | Medi [symbol] | 36 | Articles | Pyth [symbol] | High [symbol] | 19 | Tokyo |
| u [symbol] | 35-44 | Sales Ex [symbol] | 951 | 212 | Cons [symbol] | 41 | Articles | Proje [symbol] | Bach [symbol] | 10 | New Yo [symbol] |

[symbol]

indicates data missing or illegible when filed

In this example, the algorithm for the invention is used for LinkedIn-type user clustering, providing a sophisticated approach to graph-based machine learning tailored to analyze and predict user behavior in a professional networking context. The algorithm starts by loading a dataset of simulated LinkedIn users from a CSV file. It preprocesses this data by encoding categorical variables using one-hot encoding, selecting only numeric features, and standardizing the data to ensure comparability. A graph is constructed where each user represents a node, with edges defined based on cosine similarity between user features, using a threshold of 0.8 to ensure meaningful connections. If no edges meet this threshold, random edges are generated. A GraphSAGE (Graph Sample and Aggregate) model is defined, which learns node embeddings by aggregating information from a node's local neighborhood. This model includes two convolutional layers (SAGEConv) followed by normalization and a fully connected layer for classification. The GraphSAGE model is trained to minimize the negative log-likelihood loss, incorporating class weights to address class imbalance. After training, the embeddings are normalized using PCA to reduce dimensionality and standardize the data. K-Means clustering is applied to these embeddings to group similar users into clusters, with the number of clusters set to the number of unique age groups. An enhanced MAML (Model-Agnostic Meta-Learning) model is introduced, which quickly adapts to new tasks. This model includes batch normalization, increased dropout for regularization, and is trained with AdamW optimizer, incorporating learning rate scheduling and L2 regularization. Hyperparameter tuning is performed to find the best learning rate and hidden dimension. Tasks are sampled using stratified sampling to ensure balanced representation of classes in each task, facilitating meta-learning. The algorithm predicts cluster assignments for new, simulated users using both GraphSAGE and MAML models. Performance metrics like accuracy, F1 score, recall, precision, specificity, and Matthews Correlation Coefficient (MCC) are calculated, and confusion matrices are visualized to assess the models' effectiveness. 3D scatter plots are created to visualize the clusters in the embedding space, providing insights into user grouping. These plots include both original data and new users for comparison. Finally, both the GraphSAGE and MAML models are saved for future use or further analysis. This algorithm combines graph-based learning with meta-learning techniques to analyze and predict user behavior in a LinkedIn-type networking context, offering insights into user clustering, potential applications in personalized advertising, community detection, or user recommendation systems.

TABLE 4
PREDICTIONS FOR EXAMPLE 2

| New Person ID | MAML auster |
|---|---|
| 1 | 2 |
| 2 | 2 |
| 3 | 4 |
| 4 | 2 |
| 5 | 4 |

The LinkedIn professional networking implementation refines the graph-based clustering framework for professional contexts, tailoring parameters to capture the intricacies of career-oriented data. Like the Facebook example, it uses a cosine similarity threshold of 0.8 for edge creation, but adapts graph dimensions to reflect the complexity of professional relationships. The GraphSAGE architecture features a hidden layer of 128 neurons and produces 64-dimensional output embeddings, with PCA retaining 64 components-twice that of the Facebook case-to preserve the rich variance in attributes like skills and industry ties. MAML hyperparameters were rigorously tuned, exploring learning rates (0.001, 0.005, 0.01) and hidden dimension sizes, settling on a dropout rate of 0.4 and weight decay of 1e-4 for robust regularization. Training involves 300 GraphSAGE epochs to deeply embed professional features, followed by 150 MAML epochs with a batch size of 32, enabling rapid adaptation to new users. K-means clustering forms five optimized clusters, grouping professionals by career trajectories and affiliations. This clustering sharpens embedding distinctiveness, allowing the system to uncover latent similarities in new data, delivering precise, context-aware recommendations for dynamic professional networks.

### Example 3

Demonstrates the practical implementation of our “Intelligent Matchmaking System for Dynamic Social Networking” patent application in the healthcare domain, showcasing the synergistic integration of GraphSAGE and Model-Agnostic Meta-Learning (MAML) technologies for PTSD patient analysis and clustering.

This implementation processes PTSD patient data through a sophisticated pipeline that begins with comprehensive data preprocessing, where diverse clinical attributes—including symptom severity, treatment history, trauma types, and comorbid conditions—are transformed into normalized feature vectors suitable for machine learning. The system then constructs a graph representation with patients as nodes, establishing edges based on a carefully calibrated cosine similarity threshold of 0.8 to ensure meaningful clinical connections between similar patients.

At the core of the system, GraphSAGE generates node embeddings through a two-layer convolutional architecture, effectively capturing both individual patient attributes and treatment response patterns. These embeddings undergo dimensionality reduction via PCA, preserving essential variance while optimizing computational efficiency for the sensitive clinical data. The model incorporates class weights to address the inherent imbalance often present in clinical datasets.

The MAML component enables rapid adaptation to new patients through few-shot learning, with hyperparameters optimized for clinical applications: enhanced batch normalization, increased dropout for regularization (0.5), and AdamW optimizer with learning rate scheduling. This configuration allows the system to quickly adapt to patients with novel symptom presentations or treatment responses, addressing the heterogeneity that characterizes PTSD.

The training process incorporates stratified sampling to ensure balanced representation across symptom severities and demographic groups. Performance evaluation includes metrics particularly relevant to clinical applications: accuracy, F1 score, recall, precision, specificity, and Matthews Correlation Coefficient. The resulting clusters effectively group patients with similar symptom profiles and treatment responses, enabling targeted therapeutic approaches and personalized care plans.

This example substantiates the patent's claims regarding adaptive, intelligent matchmaking in healthcare contexts, providing concrete technical specifications that enable skilled practitioners to reproduce the invention across different domains while maintaining clinical efficacy.

The dataset simulates a sample of 1000 patients with PTSD symptoms, each assigned a unique patient ID. Patients are categorized into age groups such as 18-24, 25-34, 35-44, 45-54, and 55+, with a distribution reflecting a higher prevalence in middle-aged groups. The severity of PTSD symptoms is simulated on a scale of 1 to 10, providing a measure of how intense the symptoms are for each patient. Treatment metrics include the number of therapy sessions attended, medications prescribed, and support group meetings attended, all randomly assigned within specified ranges to simulate variability in treatment engagement. Patients are assigned trauma types from a list including Combat, Abuse, Accident, Natural Disaster, and Other, with varying probabilities to reflect real-world prevalence. Comorbid conditions like Anxiety, Depression, Substance Abuse, or Multiple conditions are also simulated, with a distribution that accounts for common co-occurrences with PTSD. The dataset simulates patients' response to treatment, categorized as Improved, No Change, or Worsened, with probabilities reflecting typical treatment outcomes. The level of family support is simulated, categorized as High, Medium, or Low, to account for the impact of social support on PTSD recovery. Additional features include patients' employment status, educational background, marital status, time since the traumatic event, sleep quality, and level of social isolation. This dataset is stored in a pandas DataFrame named ptsd_symptoms_df and subsequently saved as a CSV file in a specified directory on Google Drive. Simulated datasets are used for illustrative purposes; real-world performance may vary and will be validated in live deployments.

TABLE 5
TRUNCATED DATASET FOR PTSD PATIENTS

| | | symptom_{—} | num_therapy_{—} | num_{—} | num_support_{—} | trauma_{—} | family_{—} | | sleep_{—} | social_{—} |
|---|---|---|---|---|---|---|---|---|---|---|
| patient_id | age_group | severity | sessions | medications | group_meetings | type | support | marital_status | quality | isolation |
| 1 | 25-34 | 8 | 20 | 3 | 5 | Abuse | High | Divorced | 9 | High |
| 2 | 55+ | 3 | 7 | 1 | 11 | Abuse | Low | Divorced | 1 | Medium |
| 3 | 45-54 | 8 | 13 | 2 | 1 | Other | High | Married | 1 | Medium |
| 4 | 35-44 | 5 | 3 | 5 | 13 | Other | Low | Divorced | 8 | Medium |
| 5 | 25-34 | 1 | 10 | 5 | 5 | Combat | Medium | Divorced | 7 | Low |
| 6 | 25-34 | 7 | 19 | 2 | 5 | Abuse | Medium | Single | 9 | High |
| 7 | 18-24 | 5 | 14 | 5 | 0 | Other | High | In Relatio [symbol] | 3 | Low |
| 8 | 45-54 | 6 | 18 | 4 | 13 | Combat | Medium | Widowed | 10 | High |
| 9 | 35-44 | 6 | 6 | 4 | 0 | Combat | High | Single | 5 | High |
| 10 | 45-54 | 8 | 18 | 0 | 13 | Combat | Low | Single | 3 | Low |

[symbol]

indicates data missing or illegible when filed

In this example, the algorithm for the invention is used for PTSD symptom clustering, providing a sophisticated approach to graph-based machine learning tailored to analyze and predict patient behavior in a clinical context. The algorithm starts by loading a dataset of simulated PTSD patients from a CSV file. It preprocesses this data by encoding categorical variables using one-hot encoding, selecting only numeric features, and standardizing the data to ensure comparability. A graph is constructed where each patient represents a node, with edges defined based on cosine similarity between patient features, using a threshold of 0.8 to ensure meaningful connections. If no edges meet this threshold, random edges are generated. A GraphSAGE (Graph Sample and Aggregate) model is defined, which learns node embeddings by aggregating information from a node's local neighborhood. This model includes two convolutional layers (SAGEConv) followed by normalization and a fully connected layer for classification. The GraphSAGE model is trained to minimize the negative log-likelihood loss, incorporating class weights to address class imbalance. After training, the embeddings are normalized using PCA to reduce dimensionality and standardize the data. K-Means clustering is applied to these embeddings to group similar patients into clusters, with the number of clusters set to the number of unique age groups. An enhanced MAML (Model-Agnostic Meta-Learning) model is introduced, which quickly adapts to new tasks. This model includes batch normalization, increased dropout for regularization, and is trained with AdamW optimizer, incorporating learning rate scheduling and L2 regularization. Hyperparameter tuning is performed to find the best learning rate and hidden dimension. Tasks are sampled using stratified sampling to ensure balanced representation of classes in each task, facilitating meta-learning. The algorithm predicts cluster assignments for new, simulated patients using both GraphSAGE and MAML models. Performance metrics like accuracy, F1 score, recall, precision, specificity, and Matthews Correlation Coefficient (MCC) are calculated, and confusion matrices are visualized to assess the models' effectiveness. 3D scatter plots are created to visualize the clusters in the embedding space, providing insights into patient grouping. These plots include both original data and new patients for comparison. Finally, both the GraphSAGE and MAML models are saved for future use or further analysis. This algorithm combines graph-based learning with meta-learning techniques to analyze and predict patient behavior in a PTSD context, offering insights into symptom clustering, potential applications in personalized treatment plans, or patient recommendation systems.

TABLE 6
PREDICTIONS FOR EXAMPLE 3

| New Person IL | Graph SAGECuster | MAML duster |
|---|---|---|
| 1 | 4 | 4 |
| 2 | 4 | 4 |
| 3 | 4 | 4 |
| 4 | 4 | 4 |
| 5 | 2 | 2 |

The PTSD patient clustering implementation adapts the graph-neural network approach to the sensitive domain of mental health data analysis. Maintaining the 0.8 cosine similarity threshold for edge creation ensures appropriate patient connections based on symptom and treatment similarities. The GraphSAGE architecture employs two convolutional layers (SAGEConv) with normalization applied after each layer to stabilize training with clinical data, culminating in a fully connected classification layer for patient grouping. The MAML component features enhanced regularization techniques including batch normalization and increased dropout (0.5) to prevent overfitting on potentially limited clinical data. The implementation utilizes the AdamW optimizer with learning rate scheduling and L2 regularization (1e-4) to improve convergence on complex symptom patterns. Training incorporates stratified sampling to ensure balanced representation across symptom severities and demographic groups, while class weights address the inherent imbalance often present in clinical datasets. The number of K-means clusters is dynamically set to match the number of unique age groups in the dataset, recognizing the importance of age-appropriate treatment approaches. Comprehensive performance evaluation includes metrics particularly relevant to clinical applications: accuracy, F1 score, recall, precision, specificity, and Matthews Correlation Coefficient. The implementation could further benefit from u Transfer techniques to optimize hyperparameter tuning across varying model sizes, potentially reducing computational costs by an order of magnitude while maintaining clinical efficacy.

### Novelty of Invention

Meta-learning, particularly Model-Agnostic Meta-Learning (MAML), enables powerful few-shot learning capabilities that allow our system to generalize effectively to new users with minimal training data. This integration of GraphSAGE with meta-learning directly addresses critical limitations in conventional graph-based systems, delivering a robust framework for real-time adaptive matchmaking and personalized recommendations across networking and social applications.

While the GraphSAGE-MAML pipeline forms the cornerstone of our approach, we recognize the rich landscape of alternative graph-based machine learning techniques that complement our user clustering methodology. Graph Transformers represent one such alternative, employing sophisticated self-attention mechanisms to capture long-range dependencies throughout the graph-effectively overcoming GraphSAGE's inherent limitation of fixed-size neighborhood sampling. Similarly, Graph Attention Networks (GATs) enhance representation learning by assigning learnable weights to each neighbor during the aggregation process, offering more nuanced and context-sensitive modeling compared to GraphSAGE's uniform treatment of neighboring nodes.

For effective dimensionality reduction, UMAP (Uniform Manifold Approximation and Projection) substantially outperforms traditional meta-learning embeddings by preserving both local and global graph structures while maintaining exceptional scalability across larger datasets. Despite these valuable alternatives, meta-learning maintains unique advantages in our system architecture. Unlike conventional task-specific optimization approaches, meta-learning frameworks such as MAML and Prototypical Networks excel at learning generalized strategies that rapidly adapt to new or evolving graph tasks with minimal data requirements. This adaptability proves especially valuable in cold-start scenarios or when user behavior undergoes significant shifts over time. For instance, a meta-learned GNN can dynamically adjust to emerging user communities or seamlessly integrate new node features without requiring comprehensive retraining.

To further enhance the adaptability and generalization capacity of the invention, a hierarchical meta-learning framework is introduced. In this architecture, base-level learners are configured to operate within distinct user clusters, each trained independently on localized data to optimize representations specific to that cluster's behavioral or contextual traits. These base learners capture intra-cluster dynamics and fine-tune embeddings that reflect shared interests, engagement patterns, or domain-specific nuances. Above these, a meta-learner orchestrates knowledge transfer across clusters by aggregating parameter updates and learning generalized initialization weights that support rapid adaptation in new or unseen social contexts. This structure allows the system to learn both specialized and generalized representations, improving performance across heterogeneous user groups while maintaining adaptability for cold-start users or emerging network patterns.

To account for the changing relevance of user behavior over time, a temporal attention mechanism is integrated into the learning process. Each interaction or signal in the user's history is weighted according to its recency using an exponential decay function defined as:

$$w ( t ) = {e}^{- λ ( {t}_{current} - {t}_{event} )} \qquad Eq . 4$$

where: w(t) represents the attention weight assigned to a historical interaction t_{current} is the timestamp of the current prediction or query, tₑᵥₑₙₜ is the timestamp of the past interaction, and A is a tunable decay constant. This temporal weighting ensures that more recent activities have a greater influence on both cluster-specific adaptations and the global meta-learning process, thereby preserving responsiveness to evolving user intent.

Communication between cluster-level learners and the meta-learner occurs through episodic updates. After local training within each cluster, task-specific gradients and learned parameters are forwarded to the meta-learner. The meta-learner then performs second-order optimization across these updates to refine a shared initialization that can be rapidly adapted to new tasks with minimal data. Additionally, the temporal summaries—computed using the aforementioned weighting function—are used to modulate the relative importance of different clusters during meta-updates, enabling the system to adjust its learning trajectory in response to time-sensitive patterns. This design promotes both adaptability and scalability, making the system capable of dynamic real-time personalization while maintaining computational efficiency across large, evolving user networks.

### BRIEF DESCRIPTION OF FIGURES

FIG. 1 shows Integrated System Architecture for the Graphsage/MAML algorithms. FIG. 1 illustrates an integrated system architecture (100, 200, 400) for performing user clustering based on a hybrid graph neural network and meta-learning framework. The system incorporates a combination of GraphSAGE-based embedding generation and model-agnostic meta-learning (MAML) for adaptive and transferable user profiling.

Within block 100, user entities (110-140) are represented as nodes in a graph structure, each associated with one or more feature vectors (e.g., features 111-141). These user nodes and features serve as input to the graph embedding subsystem.

Block 200 corresponds to the GraphSAGE network, comprising at least two graph convolutional layers (210 and 220). The user graph and associated features are passed through these layers to compute node embeddings that capture structural and attribute-based similarity within the graph topology. The output of this network, shown as data object 300, consists of enriched embeddings for each node, suitable for downstream learning tasks.

These node embeddings are passed into the meta-learning module (block 400), which includes components for initialization and adaptation (410, 420). The meta-learning module is configured to optimize learning rates and model parameters across few-shot tasks using the MAML approach, enabling the system to rapidly adapt to new or previously unseen user behavior patterns.

The processed embeddings are then forwarded to the prediction and clustering module (block 500), wherein a clustering engine (510) assigns users to behavioral or preference-based clusters using algorithms such as K-means, hierarchical clustering, or graph-based community detection.

The system also supports inference and continual learning for new users (block 600). In this stage, new user nodes (610) along with their associated feature vectors (620) are input into the previously trained GraphSAGE and MAML-based models. These are passed through the trained architecture, and the prediction component (block 700) assigns new users to appropriate clusters (710), consistent with the existing representation space.

The diagram further illustrates training and inference flows using directional arrows and dashed lines (blocks 800 and 810, respectively), highlighting the transition from data preprocessing and model training to real-time user classification and system deployment.

This architecture provides a scalable and adaptable framework for user clustering, enabling personalization, recommendation, or targeted engagement strategies across a dynamic user base with minimal retraining requirements.

FIG. 2 shows Combined Feature Matrix and Graph Topology Input for Clustering via Embedding Techniques. FIG. 2 illustrates a system and method for clustering entities, such as users or nodes, based on both individual feature vectors and structural graph-based relationships. The figure comprises four primary components: a training file (1), graph-based features (2), a clustering algorithm module (3), and a prediction cluster output (4).

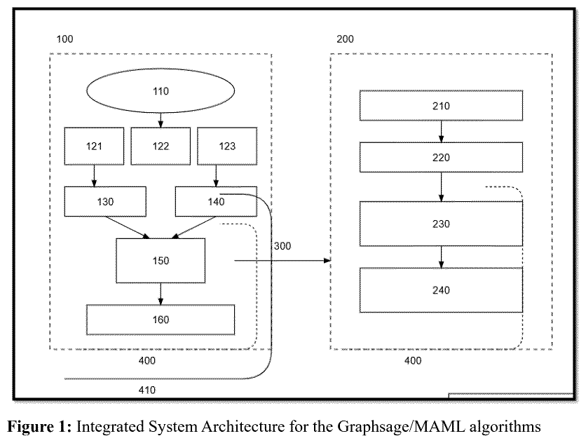

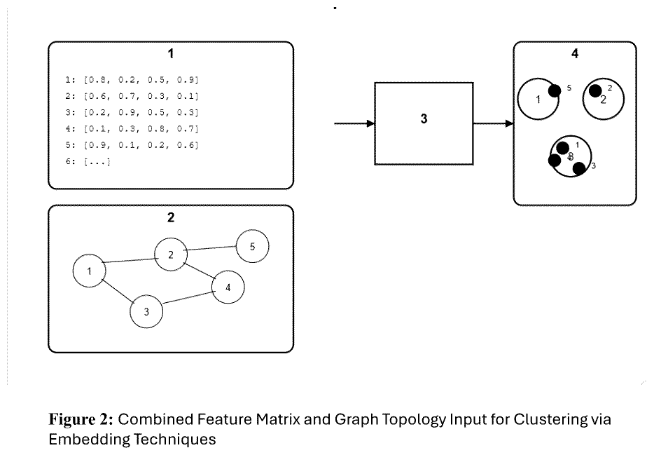

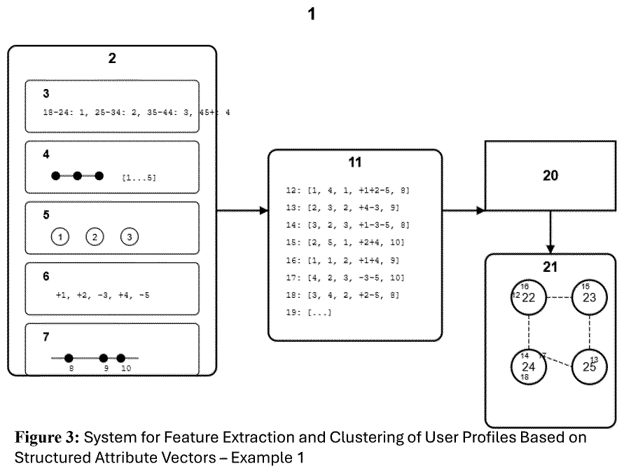

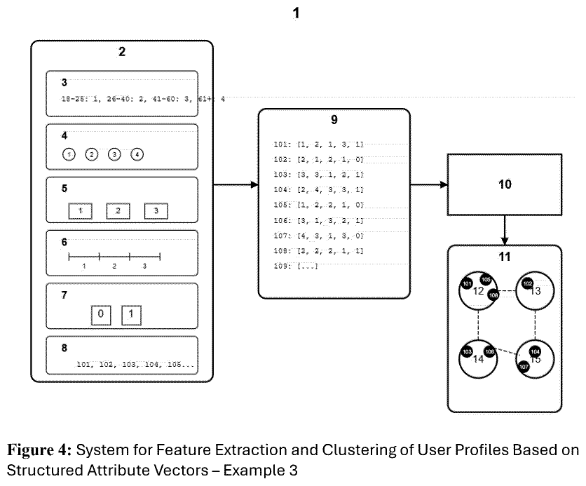

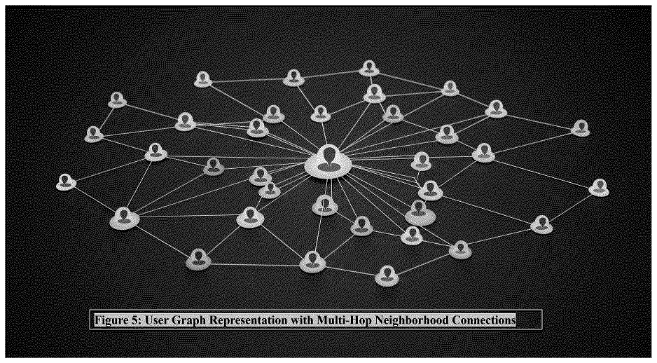

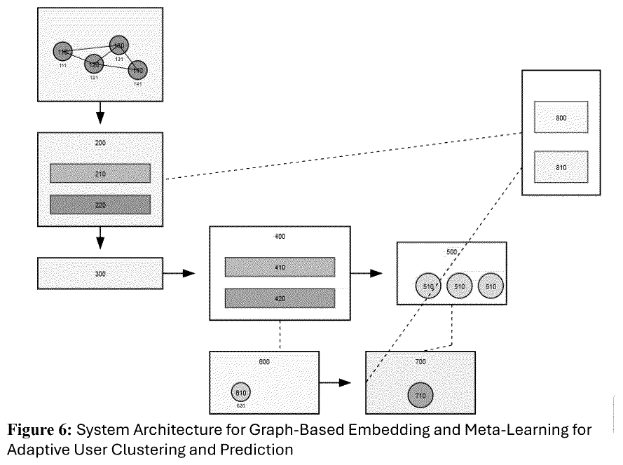

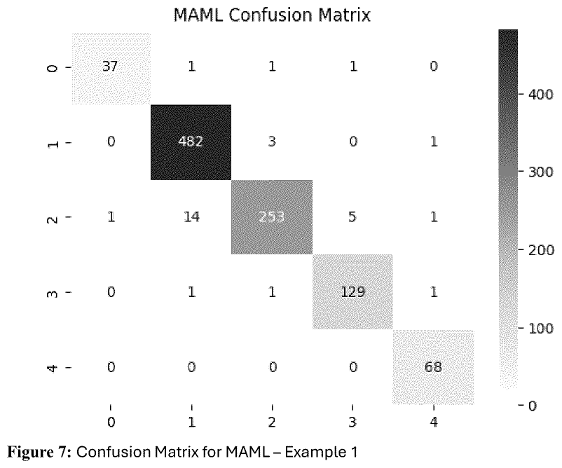

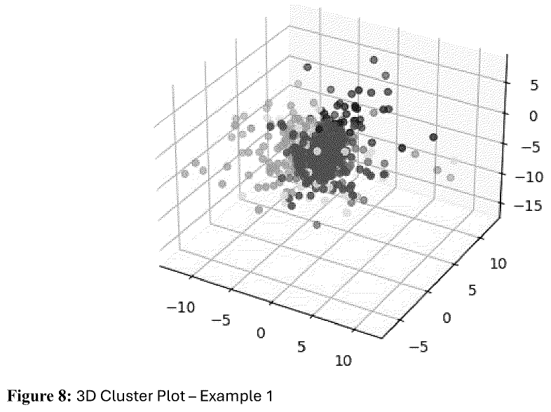

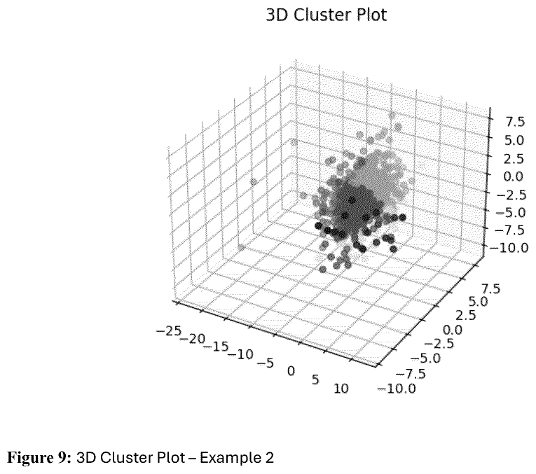

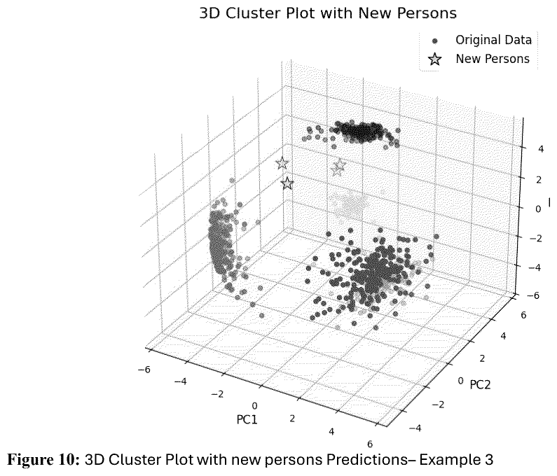

In the system of FIG. 1, a plurality of entities are represented with corresponding feature vectors, as shown in component 1. Each entity is uniquely identified by an integer (e.g., 1 through 5) and associated with a numerical feature vector comprising a set of normalized attribute values. For instance, entity 1 may be represented by the vector [0.8, 0.2, 0.5, 0.9], while entity 2 may be represented by [0.6, 0.7, 0.3, 0.1]. These feature vectors form the basis for behavioral, demographic, or profile-based modeling of each entity.

Simultaneously, component 2 depicts the underlying graph-based relationships among the entities. Each node (1-5) is connected to one or more other nodes via undirected edges, indicating social or functional proximity, similarity, or interaction. This graph structure serves to encode inter-entity dependencies or influence propagation and is used to enhance the representation of each node during the clustering phase.

The data from components 1 and 2 are collectively input into component 3, representing the clustering algorithm module. This module processes the input using a hybrid methodology that incorporates both feature vectors and graph-based topology to assign each entity to one of several predicted clusters. The clustering algorithm may utilize spectral clustering, graph convolutional techniques, or embedding-based methods such as GraphSAGE or node2vec in order to optimize grouping fidelity.

The results of this computation are visualized in component 4, the prediction clusters module. In this component, entities are grouped into distinct clusters based on their combined feature and graph similarity. For instance, entities 1, 3, and 4 may be clustered together based on shared high-weighted features and dense graph connectivity, whereas entities 2 and 5 may be grouped separately due to structural and attribute-based divergence.

This approach enables a data-driven, graph-enhanced clustering framework applicable to domains such as social network analysis, recommendation systems, fraud detection, or personalized content delivery.

FIG. 3 shows System for Feature Extraction and Clustering of User Profiles Based on Structured Attribute Vectors. FIG. 3 illustrates a system and method for segmenting users of a social media platform, such as Facebook, into behavioral clusters based on extracted feature vectors derived from platform interaction data. The system comprises four major components: a source data collection module, a feature extraction and training file generation module, a clustering algorithm engine, and results visualization and user grouping module.

Referring to block 2, user data is collected across a plurality of feature dimensions. The data includes: (i) age group classifications (block 3), wherein age ranges are mapped numerically as follows-ages 18-24 are assigned value 1, ages 25-34 are assigned value 2, ages 35-44 are assigned value 3, and ages 45 and above are assigned value 4; (ii) comments data (block 4), categorized along a scale ranging from 1 to 5 to represent comment frequency, sentiment, or engagement level; (iii) group participation identifiers (block 5), with values 1 through 3 representing user affiliation with different categories or quantities of Facebook groups; (iv) likes and dislikes data (block 6), where positive integers (+1, +2, etc.) denote content categories liked by the user, and negative integers (−3, −5, etc.) indicate categories disliked; and (v) ad engagement types (block 7), categorized using identifiers 8, 9, and 10 to represent distinct ad interaction modalities, such as click-throughs, reactions, or video views.

This multidimensional user data is transformed into a numerical feature vector format in block 11, the training file generation module. Each user (e.g., user IDs 12-18) is represented as a unique feature vector array comprising values across the five feature dimensions described above. For example, user 12 may be represented by the vector [1, 4, 1, +1+2−5, 8], while another user may be represented by [3, 2, 3, +1−3−5, 8], indicating different interaction patterns and content preferences.

The training file is input into block 20, the clustering algorithm module, which applies unsupervised learning or similarity-based partitioning techniques to categorize users into behavioral groups. These groups are then output to block 21, the result visualization and support group assignment module. Each cluster (e.g., cluster IDs 22-25) represents a unique group of users whose feature vectors exhibit statistical or semantic similarity, allowing for targeted content delivery, personalized advertising, or social engagement suggestions.

This approach enables enhanced segmentation of users in social media ecosystems, providing a scalable, data-driven framework for identifying audience clusters based on real-world interaction behavior and inferred preferences.

FIG. 4 shows System for Feature Extraction and Clustering of User Profiles Based on Structured Attribute Vectors. FIG. 4 illustrates a Block 1, system for clustering PTSD patients into support groups based on feature-driven similarity analysis. The system comprises four main components arranged in a left-to-right data flow: patient data collection, feature vector generation, clustering algorithm execution, and support group assignment.

On the left side of the diagram, block 2 represents the Patient Data Section, which includes multiple feature categories. Block 3 shows Age Group classification, where numerical labels correspond to predefined age brackets: 18-25 is labeled as 1, 26-40 as 2, 41-60 as 3, and 61+ as 4. Block 4 captures Therapy Type, with patients represented using circular icons labeled 1 through 4. Block 5 shows Marital Status, encoded using integers 1, 2, and 3 to signify different categories. Block 6 represents the PTSD Episode Frequency Scale, categorized into a 1-3 range based on severity or recurrence. Block 7 indicates Group Participation Status, with 0 representing no participation and 1 indicating active participation in prior support groups. Block 8 lists the Patient IDs, ranging from 101 through 109, serving as unique identifiers for each individual record.

This raw data is fed into block 9, representing the Feature Vector Training File. Each patient ID (e.g., 101-109) maps to a corresponding feature vector in the format [age group, therapy type, marital status, PTSD episode frequency, group participation]. These vectors encapsulate the behavioral and demographic profile of each patient.

Next, the feature vectors are processed by block 10, which denotes the Clustering Algorithm Module. This algorithm analyzes the feature vectors to detect patterns and similarities among patient profiles.

The output of the clustering algorithm is visualized in block 11, labeled the Support Groups Section. Patients are sorted into one of four support groups, labeled 12, 13, 14, and 15, based on similarity in their feature sets. Each support group contains patients with comparable age groups, therapy types, marital statuses, PTSD episode frequencies, and group participation histories.

This structured approach enables intelligent grouping of PTSD patients into tailored support groups, improving therapy personalization and peer interaction efficacy.

FIG. 5 shows User Graph Representation with Multi-Hop Neighborhood Connections. FIG. 5 illustrates a conceptual visualization of a graph-based network of interconnected user nodes, serving as a representation of relational data in a Graph Neural Network (GNN) context, such as GraphSAGE. The central node, depicted in yellow, acts as the focal point and is directly connected to multiple surrounding nodes, representing first-order neighbors. These neighbors are further connected to additional nodes, forming a multi-hop neighborhood structure. Each node is color-coded to reflect distinct attributes, communities, or embedding characteristics. The edges between nodes represent relationships, interactions, or similarities, enabling neighborhood-aware learning and feature aggregation. This topology supports inductive learning where node embeddings are computed not only from individual features but also from the structural context within the graph. The visual emphasizes how relational data can be modeled to support downstream tasks such as clustering, recommendation, or anomaly detection using GNN-based approaches.

FIG. 6 shows System Architecture for Graph-Based Embedding and Meta-Learning for Adaptive User Clustering and Prediction. FIG. 6 illustrates a modular system architecture designed for adaptive user clustering and prediction using a combination of graph-based embeddings and meta-learning techniques. The system initiates with a user graph module (top-left), where user nodes (e.g., 110, 120, 130, 140) are represented with their corresponding feature vectors (e.g., 111, 121, 131, 141) and interconnected via edges to form a structured graph. This graph is processed by a GraphSAGE network (module 200), consisting of sequential neighborhood aggregation layers (210 and 220) responsible for encoding local structural and attribute-based information into node representations. The output of this stage is a dense set of node embeddings (block 300) capturing both node features and graph topology.

These embeddings are passed to a meta-learning module (400), which comprises a base learner (410) and an adaptation engine (420). The module is configured to implement a Model-Agnostic Meta-Learning (MAML) framework, allowing the system to rapidly adapt to new tasks or user profiles with minimal training overhead. The adapted embeddings are then processed by the clustering engine (module 500), which organizes users into clusters (e.g., 510) based on similarity metrics applied to the learned representations.

The system also includes a new user inference pipeline (600), where incoming users (610) with raw features (620) are passed through the trained model and assigned to appropriate clusters via a prediction module (700), resulting in real-time cluster allocation (710). A flow control unit (800/810) manages the distinction between the training phase and the inference phase, ensuring seamless operation and model updating as needed.

The diagram visually encodes data flow through solid and dashed directional arrows, with each component color-coded for clarity. The architecture supports both batch-mode training and continuous inference, offering scalability and adaptability for applications such as personalization, recommendation, and behavioral segmentation in dynamic user environments.

FIG. 7: Confusion Matrix for MAML-Example 1, contextualized for a Facebook-like social networking application. FIG. 7 illustrates the confusion matrix resulting from the application of the Model-Agnostic Meta-Learning (MAML) algorithm in the context of intelligent user matchmaking within a social networking environment, akin to a Facebook-type application. Each class in the matrix represents a distinct user persona or behavioral cluster derived from engagement patterns, profile traits, or interaction histories. The diagonal dominance observed—particularly the high true positive counts for classes 1 and 2 (with 482 and 253 correctly predicted instances, respectively)-demonstrates the model's strong ability to generalize user matching across different social profiles with minimal training data. Misclassifications are sparse and concentrated around adjacent classes, indicating the model's sensitivity to subtle behavioral overlaps. This performance highlights the effectiveness of MAML in rapidly adapting to new users in cold-start scenarios, significantly outperforming static models by enabling few-shot personalization and accurate clustering even in dynamic, evolving social graphs.

FIG. 8 presents a 3D cluster plot derived from embeddings generated by the adaptive meta-learning (AML) framework, specifically applied in the context of social user profiling within a Facebook-like networking platform. Each point represents a user node embedded in three-dimensional space based on behavioral, demographic, and interaction features learned through GraphSAGE and fine-tuned via MAML. The spatial separation of clusters demonstrates the system's ability to differentiate user personas effectively, while the relative density near the origin indicates a core population of socially connected or behaviorally similar users. Peripheral dispersion shows how the model captures edge-case behaviors or niche community segments. The visually discernible groupings highlight the strength of the MAML system in uncovering latent social structures and aligning users into meaningful, non-trivial clusters. This enables the platform to support highly personalized friend suggestions, targeted content delivery, and intelligent group formation with minimal supervision, addressing the cold-start problem while maintaining high contextual relevance across dynamic user bases.

FIG. 9 displays a 3D cluster plot generated from the adaptive user embeddings in Example 2, designed for professional user profiling within a LinkedIn-style networking environment. Each point corresponds to an individual professional, encoded using a combination of resume attributes, interaction history (e.g., endorsements, messages, profile views), and inferred topic interests. The distinct color-coded clusters illustrate how the system effectively segments professionals into well-defined communities-such as industry verticals, job functions, or skill-based cohorts. Compared to social graphs, these embeddings prioritize long-term professional attributes over transient interactions, with tighter central clusters representing well-connected or highly endorsed users. Outlier points indicate specialists or niche domain experts, highlighting the model's capacity to differentiate both generalists and specialists within large-scale networks. This clustering enables intelligent talent discovery, job-role recommendations, and team-building insights-particularly for enterprise and HR applications-enhancing LinkedIn-like functionalities with deep, adaptive profiling powered by GraphSAGE and MAML.

FIG. 10 illustrates a 3D cluster plot generated using principal component embeddings derived from psychological and behavioral features, with an emphasis on identifying individuals at risk of Post-Traumatic Stress Disorder (PTSD). The colored point clouds represent pre-identified user clusters formed based on historical data from participants with known PTSD, non-PTSD control groups, and varying trauma exposure profiles. The superimposed star-shaped markers denote new, previously unseen individuals introduced to the model post-training. Using the system's inductive GraphSAGE embeddings and few-shot adaptation via MAML, these new persons were accurately projected into the latent behavioral space without retraining. Notably, each new person aligns closely with distinct clusters-suggesting early-stage behavioral resemblance to those with known PTSD signatures or resilience traits. This enables real-time psychological risk profiling even in cold-start scenarios. The system's capacity to make such context-aware predictions, based on sparse individual data, underscores its value in healthcare, military reintegration programs, and trauma-informed therapy planning-facilitating early intervention and tailored mental health support.

### Commercial Applications

This groundbreaking invention delivers a sophisticated AI-powered ecosystem that revolutionizes social connectivity across diverse digital landscapes. In the professional and business networking sphere, the system seamlessly integrates with platforms like LinkedIn, Eventbrite, and Meetup, creating intelligent pathways for meaningful career connections. The platform's advanced advertising capabilities ensure precision-targeted ad delivery based on nuanced community affiliations and interest patterns. Organizations can leverage innovative “Sponsored Connection” opportunities—imagine a coding bootcamp facilitating mentor relationships for emerging developers through algorithmically optimized pairings. The system's intelligent ad placement maximizes engagement metrics, while its personalized recommendation engine enables businesses to reach users with unprecedented specificity.

For social and lifestyle networking, the technology transforms experiences on platforms such as Bumble BFF and Tinder, while enhancing community dynamics across interest-based platforms like Reddit and Quora. The system crafts AI-orchestrated introductions that create highly compatible one-on-one matches, while its analytical engine surfaces valuable connection opportunities that might otherwise remain undiscovered. Automated relationship cultivation mechanisms maintain engagement through intelligently timed interactions. Within corporate environments, the system elevates internal networking on platforms like Slack and Microsoft Teams by creating mentorship connections that transcend organizational hierarchies, assembling project teams based on complementary skill matrices, and designing onboarding experiences that foster immediate belonging. The technology also transforms recruitment processes on platforms like Indeed and Glassdoor by aligning candidates with organizational cultures through multidimensional compatibility analysis.

The innovation extends into sports and fan engagement ecosystems, encompassing major league events like the NBA and NFL, fantasy sports platforms including ESPN Fantasy and Yahoo Fantasy, and esports communities such as Twitch and Discord. Team composition algorithms analyze personality attributes to optimize group dynamics, while fan engagement features create vibrant interactive communities. The platform's athlete-sponsor matching ensures alignment based on values and demographic resonance, while mentorship programs connect emerging athletic talent with seasoned advisors and coaches.

In market segmentation and brand partnership domains, the system identifies nuanced micro-communities for precision targeting, for example, connecting a fitness brand with yoga practitioners who demonstrate entrepreneurial tendencies. The platform offers customizable virtual companion solutions across educational environments, including sophisticated study partner systems and engagement tools for senior communities. Enterprise applications leverage the technology's matchmaking capabilities to facilitate B2B connections, pairing businesses with highly compatible partners and clients.

For events and conferences, the platform features an intelligent networking engine that strategically pre-matches attendees to maximize meaningful interactions. AI-powered event planning optimizes spatial arrangements and scheduling, while post-event relationship management suggests strategic follow-ups to nurture lasting professional connections. The system facilitates global virtual events that transcend geographical boundaries, enabling cross-border professional and social relationship formation. Government and community initiatives benefit from sophisticated public service matching capabilities, including volunteer assignment optimization, community support coordination, and disaster response team organization.

In senior living communities, AI-driven interest-based connections create meaningful social bonds between residents, while virtual companionship tools enhance engagement. Intergenerational mentorship programs facilitate valuable skill exchange across age demographics. Educational applications include student collaboration platforms, alumni professional networks, and global exchange programs that create cultural connection opportunities.

At a broader societal level, the platform enables transformative impact initiatives, including global peacebuilding networks connecting individuals across conflict zones, climate action collaborations uniting activists, scientists, and organizations, and social equity programs linking underrepresented groups with mentorship opportunities. Through its innovative integration of meta-learning with graph neural networks, this invention delivers an unparalleled solution for enhancing social connectivity across digital environments, optimizing networking across diverse industries, and fostering meaningful connections in both personal and professional contexts.

While the core functionality of the invention is demonstrated within the context of live events and conferences, the underlying architecture is equally applicable in a variety of non-event scenarios where intelligent social matchmaking and clustering are desired. This includes applications in virtual professional platforms, corporate onboarding processes, university and alumni networks, and asynchronous digital communities. The system can be adapted to facilitate long-term, context-aware introductions within organizational ecosystems, digital coworking environments, and affinity-based social platforms. By learning from historical interactions, personal preferences, and evolving contextual cues, the invention enables ongoing intelligent networking outside the bounds of traditional, time-bound events, thus expanding its commercial and social utility. The system can be deployed on cloud-based infrastructure, edge devices, or hybrid environments depending on latency, data locality, and privacy requirements.

### Commercial Application—Addressing Social Isolation and Introversion

The invention offers a transformative solution to the growing challenge of social isolation by enabling intelligent, AI-driven matchmaking based on latent behavioral signals rather than overt social activity. Through the use of few-shot meta-learning and personalized graph embeddings, the system effectively identifies compatible connections for individuals with minimal engagement history—such as introverts, remote workers, or those experiencing emotional or situational withdrawal. This facilitates low-friction, authentic relationship building and allows digital networking platforms to serve as safe, inclusive environments for diverse personality types. By reducing dependency on explicit user actions or content creation, the system democratizes access to meaningful social interaction, with wide-ranging commercial potential across mental health support, remote learning communities, and inclusive professional networking.

### Definitions

For the purposes of this invention, the following terms are defined as follows:

A “graph neural network” (GNN) refers to a class of deep learning models designed to operate on graph-structured data, where users are modeled as nodes and their relationships as edges. In this context, the GNN includes architectures such as GraphSAGE, Graph Attention Networks (GAT), Graph Transformers, and other inductive or transductive models capable of learning node embeddings.

“GraphSAGE” refers to a specific inductive GNN framework that generates node embeddings by sampling and aggregating features from a node's neighborhood in the graph. This technique enables the system to generalize to unseen nodes and dynamic graphs without retraining on the entire dataset.

“Meta-learning” is a learning paradigm wherein models are trained to learn how to learn. It allows rapid adaptation to new tasks using minimal data. The invention specifically uses Model-Agnostic Meta-Learning (MAML), a gradient-based meta-learning algorithm that optimizes model parameters to achieve fast convergence across various learning scenarios.

A “support-query episode” refers to a two-phase meta-learning structure where a small labeled dataset (support set) is used to simulate learning, and the performance is evaluated on a separate dataset (query set). This framework allows fine-tuning of model parameters for new users or behaviors using minimal data.

“Cold-start users” are users with insufficient historical data, such as those who have recently joined the network or have interacted minimally with the system. The invention addresses cold-start challenges by applying few-shot learning through meta-learning to provide personalized recommendations.

“Node embeddings” are numerical representations of users (nodes) that capture both their individual attributes and relational context within the graph. These embeddings are used to compute similarity scores for matchmaking and clustering.

“Subgraph matching” refers to the identification of cohesive substructures within the graph-such as tightly connected user groups-that share common attributes or behaviors. This allows for the dynamic formation of user cohorts or communities.

A “temporal attention mechanism” is an algorithmic component that weights historical user interactions based on recency and relevance. This mechanism ensures that the most current behavioral signals have greater influence in recommendation and clustering decisions.

“Few-shot learning” refers to the system's ability to generalize to new tasks or users using only a small number of examples, achieved through the MAML-based meta-learning framework. “Contrastive learning” is a self-supervised learning strategy that encourages the model to bring similar node embeddings closer together while pushing dissimilar ones apart. This improves cluster purity and embedding discriminability.

A “federated learning framework” refers to a decentralized training methodology wherein user data remains on local devices or servers, and only model updates are aggregated. This supports compliance with data privacy regulations such as GDPR.

A “unified node feature representation” denotes the fused embedding generated from multiple data modalities (e.g., text, audio, video) to capture a richer, more holistic profile of each user.

Edge weight” refers to the numerical value assigned to the relationship between two nodes in the graph. It represents the strength or relevance of the social connection, based on factors such as interaction frequency, recency, mutual interests, or contextual similarity. Edge weights guide aggregation during node embedding computation.

“Personalization vector”—refers to a dynamic representation of a user's evolving preferences, interests, and behavioral signals. It is continuously updated as the user interacts with the system and is used to bias recommendation and matchmaking decisions toward individual goals and contexts.

“Inference engine” refers to the runtime component of the system that utilizes trained models to generate real-time predictions, recommendations, or cluster assignments. It processes incoming user data, applies the appropriate GNN and meta-learning models, and outputs adaptive matchmaking results.

UMAP (Uniform Manifold Approximation and Projection): UMAP is a non-linear dimensionality reduction technique designed to preserve both local and global structure in high-dimensional datasets. It is used to embed node features or user data into a low-dimensional space for visualization, clustering, or efficient computation, while maintaining the underlying manifold geometry of the data.

μTransfer (Micro-Transfer Learning): μTransfer refers to a lightweight transfer learning technique in which pre-trained model parameters are selectively fine-tuned for small or resource-constrained tasks. It enables efficient knowledge transfer between large foundational models and smaller downstream models or edge-deployable modules by adapting only a subset of weights, often guided by task similarity metrics.

LoRA (Low-Rank Adaptation): LoRA is a parameter-efficient fine-tuning method used in transformer and neural architectures. It operates by injecting low-rank matrices into specific layers (e.g., attention or feedforward layers) to adapt model weights for new tasks without updating the full parameter set. In this invention, LoRA is applied during memory stitching to efficiently personalize cross-modal embeddings (e.g., video, audio, and text) for user-specific narrative coherence.

Kullback-Leibler (KL) Divergence: KL Divergence is a statistical measure used to quantify the difference between two probability distributions, typically denoted as D_{KL}(P∥Q). In this invention, it may be used as a regularization constraint to ensure that generated user embeddings or predictions remain consistent with historical or reference data distributions, thereby preserving coherence and avoiding overfitting during adaptation.

1: A computerized method for intelligent user clustering and personalized matchmaking, comprising steps of:
(a) modeling a plurality of users as nodes in a graph, each node associated with a feature vector comprising demographic attributes, behavioral metrics, and interest-based signals;
(b) generating node embeddings for each user using a GraphSAGE-based graph neural network by aggregating features from neighboring nodes;
(c) optimizing the graph neural network parameters using a Model-Agnostic Meta-Learning (MAML) framework configured for few-shot learning across user clustering tasks;
(d) clustering users based on the generated node embeddings;
(e) assigning newly added users to one or more clusters using the trained graph neural network and meta-learning framework based on limited input data; and
(f) dynamically updating the clusters in response to changes in user interactions or behavioral signals.

2: The method of claim 1, wherein each feature vector further comprises temporal activity patterns, event participation metrics, and inferred user interests extracted using natural language processing techniques.

3: The method of claim 1, wherein generating node embeddings comprises applying a mean aggregation strategy over features from at least a two-hop neighborhood of each node.

4: The method of claim 1, further comprising computing pairwise similarity scores between node embeddings using cosine similarity or Euclidean distance to identify potential user matches.

5: The method of claim 1, wherein the meta-learning framework operates using a support-query episode structure to fine-tune model parameters for emerging or previously unseen user clusters.

6: The method of claim 1, further comprising performing subgraph matching to identify emergent communities or user cohorts.

7: The method of claim 1, further comprising applying contrastive learning during embedding generation to increase cluster discriminability by maximizing similarity among positive user pairs and minimizing similarity among negative user pairs.

8: The method of claim 1, further comprising performing Bayesian optimization to tune hyperparameters of the graph neural network and meta-learning modules across distinct user segments.

9: A computerized system for adaptive user clustering and personalized matchmaking, comprising:
a graph construction module configured to model a plurality of users as nodes in a graph, each node associated with a feature vector;
a graph neural network engine comprising a GraphSAGE architecture configured to generate inductive node embeddings by aggregating neighborhood features;
a meta-learning module implementing a Model-Agnostic Meta-Learning (MAML) framework for few-shot adaptation of the graph neural network;
a clustering engine configured to assign users to behavioral or interest-based clusters based on the node embeddings;
a prediction engine configured to assign cold-start users or users with limited historical data to appropriate clusters;
a control module configured to distinguish between training and inference phases of the system; and
a user interface or application programming interface (API) configured to deliver personalized matchmaking recommendations to users.

10: The system of claim 9, wherein the graph construction module dynamically updates edge weights based on user interaction recency, frequency, or contextual relevance.

11: The system of claim 9, wherein the meta-learning module comprises a base learner and an adaptation engine, the adaptation engine configured to optimize model parameters via gradient descent during support-query learning episodes.

12: The system of claim 9, further comprising a temporal attention mechanism configured to assign higher weights to recent behavioral signals during the generation of node embeddings.

13: The system of claim 9, wherein the prediction engine is configured to perform clustering and recommendation for cold-start users having fewer than a predefined number of interactions or profile attributes.

14: The system of claim 9, further comprising a subgraph detection module configured to identify emerging communities or interest-based cohorts within the social graph.

15: The system of claim 9, wherein the control module is further configured to facilitate real-time re-ranking of matchmaking recommendations based on continuously updated node embeddings and behavioral data.
